(19) United States
(12) Patent Application Publication
(10) Pub. No.: US 2008/0051165 A1
(43) Pub. Date: Feb. 28, 2008

(54) RF POWER CONTROL USING PROXIMITY SENSOR

(75) Inventors: John M. Burgan, North Palm Beach, FL (US); William E. Ceres, Palm Beach Gardens, FL (US); Donald R. Dale, West Palm Beach, FL (US); Joseph Patino, Pembroke Pines, FL (US); Carlos A. Rivera-Cintron, Lake Worth, FL (US); Russell L. Simpson, Miami, FL (US)

Correspondence Address: CUENOT & FORSYTHE, L.L.C., 12230 FOREST HILL BLVD., SUITE 120, WELLINGTON, FL, 33414, US

(73) Assignee: MOTOROLA, INC., Schaumburg, IL (US)

(21) Appl. No.: 11/467,907

(22) Filed: Aug. 28, 2006

(51) Int. Cl. H04B 17/00; H04M 1/00

(52) U.S. Cl. 455/575.6; 455/67.11

(57) ABSTRACT

A communication device (100) that includes a transceiver (210), a sensor (230) that detects proximity of the communication device with respect to a user (105), and a controller (205) that selectively changes at least one operating parameter of the transceiver when the sensor detects that the communication device is proximate to the user. The operating parameter that is changed can includes a transmit power of communication signals generated by the transceiver and/or a data transmission rate of signals generated by the transceiver. The communication device also can include a first antenna (215) and a second antenna (220), and the operating parameter that is changed can include a selection of the first antenna or the second antenna through which to transmit an RF signal. The sensor can sense a value of electric field intensity, a value of capacitance, or acoustically measure a distance between the communication device and the user.

### BACKGROUND OF THE INVENTION

1. Field of the Invention

The present invention generally relates to RF communications and, more particularly, to personal communication devices.

2. Background of the Invention

The use of mobile stations, such as cellular telephones, has become pervasive throughout much of the world. While being operated, most modern cellular telephones are held very close to the human body, for example next to a user's ear or on the user's belt. Some experts believe, however, that it may be desirable to reduce the interaction between RF signals generated by a mobile station and the human body. This can be achieved, for example, with use of a wireless headset. The wireless headset typically can communicate with the mobile station using a relatively low power RF signal, while the mobile station, which may be located a distance away from the user, can communicate with a communications network using a higher power RF signal. Nevertheless, many users prefer not to use a wireless headset.

### SUMMARY OF THE INVENTION

The present invention relates to a communication device that includes a transceiver, a sensor that detects proximity of the communication device with respect to a user, and a controller that selectively changes at least one operating parameter of the transceiver when the sensor detects that the communication device is proximate to the user. The operating parameter that is changed can include a transmit power of communication signals generated by the transceiver and/or a data transmission rate of signals generated by the transceiver.

The communication device also can include a first antenna and a second antenna, and the operating parameter that is changed can include a selection of the first antenna or the second antenna through which to transmit an RF signal. The communication device further can include a display. An operational state of the display can be changed when the sensor detects that the communication device is proximate to the user.

In one arrangement, the sensor can sense a value of electric field intensity or a value of capacitance. For example, the sensor can include at least one conductive element communicatively linked to a processor. The processor can measure the value of electric field intensity or the value of capacitance associated with the conductive element. In another arrangement, the sensor can acoustically measure a distance between the communication device and the user.

The present invention also relates to a method for reducing interaction between a communication device and user. The method can include detecting whether the communication device is proximate to a user. In response to detecting that the communication device is proximate to the user, at least one operating parameter of a transceiver of the communication device can be selectively changed. For example, a transmit power of communication signals generated by the transceiver can be changed. A data transmission rate of signals generated by the transceiver also can be changed. In another arrangement, changing at least one operating parameter can include changing a selection of a first antenna or a second antenna through which to transmit an RF signal.

The method also can include changing an operational state of a display of the communication device in response to detecting that the communication device is proximate to the user. Detecting whether the communication device is proximate to the user can include measuring an electric field intensity or measuring a capacitance. In another arrangement, detecting whether the communication device is proximate to the user can include acoustically measuring a distance between the communication device and the user.

### BRIEF DESCRIPTION OF THE DRAWINGS

Preferred embodiments of the present invention will be described below in more detail, with reference to the accompanying drawings, in which:

FIG. 1 depicts a communication device and a user that are useful for understanding the present invention;

FIG. 2 depicts a block diagram of a communication device that is useful for understanding the present invention;

FIG. 3 depicts a printed circuit board having conductive elements that are useful for understanding the present invention; and

FIG. 4 is a flowchart that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

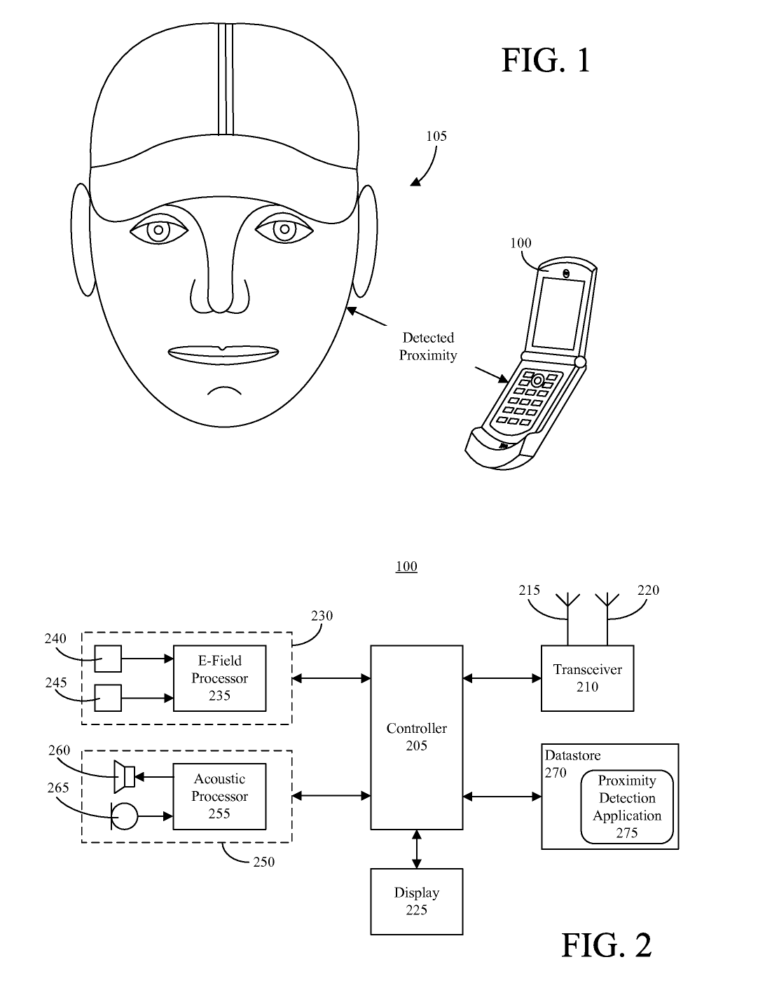

FIG. 1 depicts a communication device 100 and a user 105 that are useful for understanding the present invention. The communication device 100 can detect whether it is proximate to the user 105 and, based upon the detection, selectively change an operating parameter of its transceiver. For example, a transmit power of the communication device 100 can be reduced from a high power level to a reduced power level. Other operating parameters of the communication device 100 also can be changed, as will be described herein. When the communication device 100 detects that it is no longer proximate to the user 105, the operating parameter can be changed to a different setting. For instance, the communication device's transmit power can be increased back to the high power level to improve signal quality.

FIG. 2 depicts a block diagram of the communication device 100. The communication device 100 can be a mobile station, such as a mobile computer, a personal digital assistant (PDA) or a mobile telephone, or any other electronic apparatus that may be used to wirelessly telecommunicate and/or communicate messages. The communication device 100 can include a controller 205. The controller 205 can comprise, for example, a central processing unit (CPU), a digital signal processor (DSP), an application specific integrated circuit (ASIC), a programmable logic device (PLD), a plurality of discrete components that cooperate to process data, and/or any other suitable processing device.

The communication device 100 also can include a transceiver 210 that is used by the communication device 100 to communicate with a communications network. The transceiver 210 can communicate data via IEEE 802 wireless communications, WPA, WPA2, GSM, TDMA, CDMA, WCDMA, direct wireless communication, TCP/IP, or any other suitable form of wireless communications. The transceiver 210 can be communicatively linked to at least one antenna 215. A second antenna 220 also may be provided.

In one arrangement, the transceiver 210 may selectively propagate RF signals using the first antenna 215 or the second antenna 220. In another arrangement, the transceiver 210 can be communicatively linked to the first antenna 215 and a second transceiver (not shown) can be communicatively linked to the second antenna 220. Use of multiple antennas 215, 220 can be beneficial in that the first antenna 215 can be optimized for highest signal quality when it is not proximate to a user, while the second antenna 220 can be optimized for highest signal quality when it is proximate to a user. The antenna 220, for instance, can be designed to have a low output impedance and/or to generate a field pattern in which the strongest signals are generated away from the user when the communication device 100 is used in its intended manner.

A display 225 also can be provided on the communication device 100. The display 225 can be a liquid crystal display (LCD), a liquid crystal on silicon (LCOS) display, a plasma display, a cathode ray tube (CRT), or any other display suitable for presenting menu items. In one arrangement, the display can be a touch screen that receives tactile user inputs.

The communication device 100 also can include one or more sensors that detect proximity of the communication device to a user. For example, an electric field sensor 230 can be provided. The electric field sensor 230 can include an electric field processor 235, for example an electric field integrated circuit (E-field IC). Electric field integrated circuits are known to the skilled artisan. The electric field sensor 230 also can include one or more conductive elements 240, 245 communicatively linked to the processor 235. The processor 235 can apply a voltage to the conductive elements 240, 245 and measure one or more parameters that can be affected by the presence of organic tissue in proximity to the conductive elements 240, 245. For example, organic tissue in the proximity of the conductive elements 240, 245 can cause an increase in capacitance between the respective conductive elements 240, 245, and thus an increase in electric field intensity. Accordingly, the processor 235 can measure the electric field intensity and/or the capacitance to detect the presence of organic tissue.

When proximate to the conductive elements 240, 245, conductive materials such as metal and materials with a high dielectric constant also may affect the level of electric field intensity or capacitance associated with the conductive elements 240, 245. However, proximity of such materials may result in electric field intensity/capacitance values that are different than those values resulting from organic tissue being proximate to the conductive elements 240, 245. Accordingly, a range of electric field intensity or capacitance values can be identified which indicate that the conductive elements 240, 245 are proximate to the user. Such values may depend, at least in part, on the spacing between the conductive elements 240, 245 (when a plurality of conductive elements are used), and electrical properties of materials comprising the communication device 100 (e.g. permittivity, permeability, conductivity, etc.). The identified values then can be used to establish minimum and maximum threshold values for electric field intensity and/or capacitance in order to differentiate organic tissue from other materials.

In another arrangement, the communication device 100 can include an acoustic sensor 250 that acoustically measures a distance between the communication device 100, for instance using ultrasonic acoustic signals. The acoustic sensor 250 can include an acoustic processor 255, an output acoustic transducer 260, and an input acoustic transducer 265. In operation, the acoustic processor 255 can apply an electric signal at an ultrasonic frequency to the output transducer 260 to generate an ultrasonic acoustic signal. The output transducer 260 can be positioned in the communication device 100 so that it propagates the ultrasonic acoustic signal toward the user when the communication device 100 is used in its intended manner. An echo of the ultrasonic acoustic signal can be detected by the input acoustic transducer 265, and the acoustic processor 255 can measure the time delay between the ultrasonic acoustic signal being propagated and the echo of the ultrasonic acoustic signal being received. Based on this time delay, the acoustic processor 255 can determine the distance between the communication device 100 and the user, and thus determine whether the communication device 100 is proximate to the user.

Properties of the echo which indicate organic tissue can be identified. For instance, the spectral content of the echo that is generated when the ultrasonic acoustic signal reflects off of organic tissue can be identified. Echos which are detected that have similar spectral content then can be identified as being indicative of echos being reflected off of organic tissue as opposed to other materials. Accordingly, the spectral content of the echos can be processed to differentiate organic tissue from other materials.

The communication device 100 further can include a datastore 270. The datastore 270 can include one or more storage devices, each of which can include a magnetic storage medium, an electronic storage medium, an optical storage medium, a magneto-optical storage medium, and/or any other storage medium suitable for storing digital information. In one arrangement, the datastore 270 can be integrated into the controller 205. A proximity detection application 275 can be contained on the datastore 270. The proximity detection application 275 can be executed by the controller 205 to implement the methods and processes described herein.

In operation, the electric field sensor 230 and/or the acoustic sensor 250 can be used to detect a proximity of the communication device 100 with respect to the user. For example, the sensors 230, 250 can detect an approximate distance between the communication device 100 and the user. If either of the sensors 230, 250 detect that the communication device 100 is proximate to the user, the controller 205 can provide a control signal to the transceiver 210 that indicates to the transceiver 210 to transmit communication signals at a low power level. Use of the low power level can reduce the amount of power consumed by the communication device 100 during operation. The communication device 100 also can change a data transmission rate of signals generated by the transceiver 210, which can reduce signal errors when low transmission power is used.

In an arrangement in which the communication device 100 includes a plurality of antennas 215, 220, the transceiver 210 can cease transmitting through the first antenna 215 and begin transmitting through the second antenna 220. Alternatively, if the transceiver 210 is communicatively linked to the first antenna 215 and a second transceiver (not shown) is communicatively linked to the second antenna 220, the first transceiver 210 can cease transmitting and the second transmitter can begin transmitting.

When the communication device 100 is proximate to the user, for instance held against the user's head, the display 225 may not be needed since, in that position, it likely will not be viewed by the user. Accordingly, when either of the sensors 230, 250 detects that the communication device 100 is proximate to the user, the controller 205 can change an operational state of the display 225, for example by turning off the display. In this manner the controller 205 can further reduce the power consumption of the communication device 100.

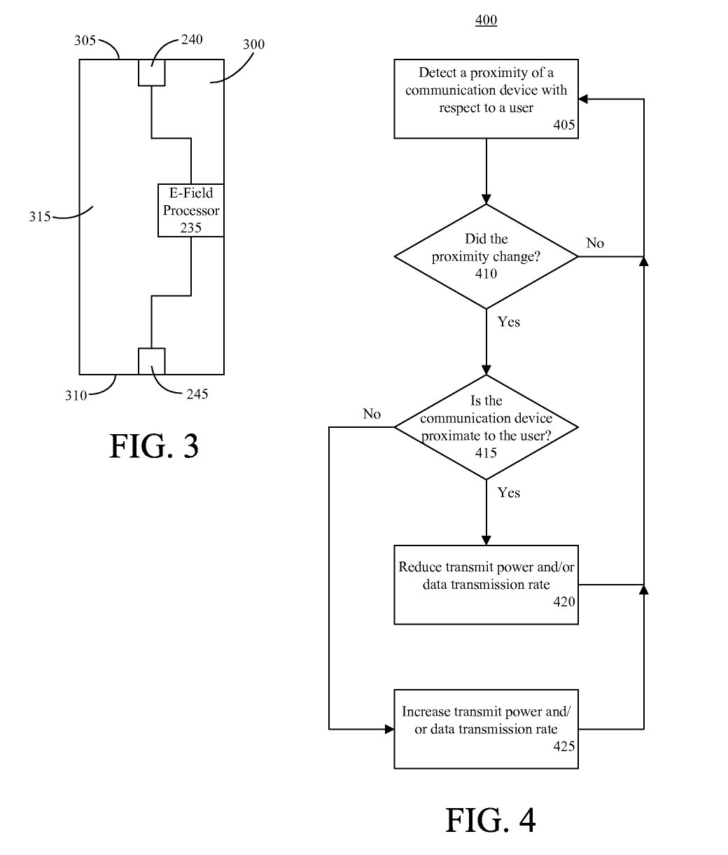

FIG. 3 depicts a printed circuit board (PCB) 300 having the conductive elements 240, 245 communicatively linked to the electric field processor 235. Notably, the conductive elements 240, 245 can be formed on the PCB 300 in the same manner, and during the same process, in which circuit traces are formed. Accordingly, the conductive elements 240, 245 can be implemented with virtually no added manufacturing costs.

In one arrangement in which a plurality of conductive elements 240, 245 are used, as opposed to a single conductive element 240, the respective conductive elements 240, 245 can be positioned at opposing edges 305, 310 of the PCB 300. Furthermore, the conductive elements 240, 245 can be positioned on a side 315 of the PCB 300 that is nearest to the user's head or body while the communication device's earpiece is being held next to a user's ear. Additional conductive elements (not shown) also can be positioned on the side 315, or on the side (not shown) of the PCB 300 that is opposite the side 315. Such additional conductive elements can improve sensitivity of the electric field sensor. In another arrangement, shielding can be provided proximate to the opposing side of the PCB 300 to reduce interference caused by other materials during proximity detection.

FIG. 4 is a flowchart presenting a method 400 which is useful for understanding the present invention. Beginning at step 405, proximity of a communication device with respect to a user can be detected. Referring to decision box 410, a determination can be made whether the proximity changed, for example whether the communication device moved from a position that is not proximate to the user to a position that is proximate to the user, or from a position that is proximate to the user to a position that is not proximate to the user.

Referring to decision box 415, if the proximity does change, a determination can be made whether the communication device is now proximate to the user. If so, the transmit power of the transceiver can be reduced and a data transmission rate can be reduced. Other operating parameters also can be changed. For instance, a different antenna can be selected to transmit communication signals and a display can be deactivated.

If the communication device is no longer proximate to the user, at step 425 the transmit power and the data transmission rate can be increased. In addition, a different antenna can be selected to transmit the communication signals and the display can again be activated. Referring again to step 405, detection of proximity between the communication device and the user can continue.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention also can be embedded in an application product, which comprises all the features enabling the implementation of the methods described herein, and which when loaded in a processing system is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

This invention can be embodied in other forms without departing from the spirit or essential attributes thereof. Accordingly, reference should be made to the following claims, rather than to the foregoing specification, as indicating the scope of the invention.

What is claimed is:

1. A communication device, comprising:
at least one transceiver;
a sensor that detects proximity of the communication device with respect to a user; and
a controller that selectively changes at least one operating parameter of the transceiver when the sensor detects that the communication device is proximate to the user.

2. The communication device of claim 1, wherein the operating parameter that is changed comprises a transmit power of communication signals generated by the transceiver.

3. The communication device of claim 1, wherein the operating parameter that is changed comprises a data transmission rate of signals generated by the transceiver.

4. The communication device of claim 1, further comprising:
a first antenna; and
a second antenna;
wherein the operating parameter that is changed comprises a selection of the first antenna or the second antenna through which to transmit an RF signal.

5. The communication device of claim 1, further comprising a display, an operational state of the display being changed when the sensor detects that the communication device is proximate to the user.

6. The communication device of claim 1, wherein the sensor senses a value of electric field intensity or a value of capacitance.

7. The communication device of claim 6, wherein the sensor comprises at least one conductive element communicatively linked to a processor, the processor measuring the value of electric field intensity or the value of capacitance associated with the conductive element.

8. The communication device of claim 1, wherein the sensor acoustically measures a distance between the communication device and the user.

9. A communication device, comprising:
a transceiver;
a sensor that senses a value of electric field intensity or a value of capacitance to detect proximity of the communication device with respect to a user; and
a controller that selectively changes at least one operating parameter of the transceiver when the sensor detects that the communication device is proximate to the user.

10. The communication device of claim 9, wherein the operating parameter that is changed comprises a transmit power of communication signals generated by the transceiver.

11. The communication device of claim 9, wherein the operating parameter that is changed comprises a data transmission rate of signals generated by the transceiver.

12. The communication device of claim 9, further comprising:
a first antenna; and
a second antenna;
wherein the operating parameter that is changed comprises a selection of the first antenna or the second antenna through which to transmit an RF signal.

13. The communication device of claim 9, further comprising a display, an operational state of the display being changed when the sensor detects that the communication device is proximate to the user.

14. A method for reducing interaction between a communication device and user, comprising:
detecting whether the communication device is proximate to a user; and
responsive to detecting that the communication device is proximate to the user, selectively changing at least one operating parameter of a transceiver of the communication device.

15. The method of claim 14, wherein changing at least one operating parameter comprises changing a transmit power of communication signals generated by the transceiver.

16. The method of claim 14, wherein changing at least one operating parameter comprises changing a data transmission rate of signals generated by the transceiver.

17. The method of claim 14, wherein changing at least one operating parameter comprises changing a selection of a first antenna or a second antenna through which to transmit an RF signal.

18. The method of claim 14, further comprising:
responsive to detecting that the communication device is proximate to the user, changing an operational state of a display of the communication device.

19. The method of claim 14, wherein detecting whether the communication device is proximate to the user comprises measuring an electric field intensity or measuring a capacitance.

20. The method of claim 14, wherein detecting whether the communication device is proximate to the user comprises acoustically measuring a distance between the communication device and the user.
